(19) United States
(12) Patent Application Publication
(10) Pub. No.: US 2009/0184707 A1
(43) Pub. Date: Jul. 23, 2009

(54) Electromagnetic barrier for use in association with inductive position sensors

(76) Inventor: Robert H. Luetzow, Lytle Creek, CA (US)

Correspondence Address: KRIEG DEVAULT LLP, ONE INDIANA SQUARE, SUITE 2800, INDIANAPOLIS, IN, 46204-2079, US

(21) Appl. No.: 12/315,267

(22) Filed: Dec. 1, 2008

Related U.S. Application Data
(60) Provisional application No. 61/004,640, filed on Nov. 29, 2007.

(51) Int. Cl. G01B 7/14

(52) U.S. Cl. 324/207.17

(57) ABSTRACT

An inductive position sensing system including an inductive position sensor and an electromagnetic barrier positioned adjacent the sensor to shield the sensor from induced electromagnetic field interference. The electromagnetic barrier is formed of a soft magnetic composite material comprising a soft magnetic filler material dispersed within a non-magnetic matrix or binder material. In one embodiment, the non-magnetic matrix material comprises a non-metallic material, and more specifically comprises a polymeric material. In another embodiment, the soft magnetic filler material comprises an iron-based material, and more specifically comprises powder particles formed of iron or an iron alloy dispersed within the non-magnetic matrix material.

### CROSS REFERENCE TO RELATED APPLICATIONS

The present application claims the benefit of U.S. Provisional Application No. 61/004,640 filed on Nov. 29, 2007, the contents of which are hereby incorporated by reference in their entirety.

### FIELD OF THE INVENTION

The present invention relates generally to the field of position sensors, and more particularly, but not exclusively, relates to an electromagnetic barrier for use in association with an inductive position sensor to shield the sensor from induced electromagnetic field interference.

### BACKGROUND

Various types of position sensors are used in automotive applications to determine the relative position of various structures or devices. Such position sensors include, for example, inductive position sensors. It has been found that inductive position sensors are susceptible to electromagnetic interference from electro-mechanical devices or metallic materials such as iron, steel, copper and aluminum, which could potentially lead to faulty operation of the sensor and/or erroneous sensor output. Thus, there remains a need for an electromagnetic barrier for use in association with inductive position sensors to eliminate or reduce the negative effects of induced electromagnetic field interference. The present invention satisfies this need and provides other benefits and advantages in a novel and unobvious manner.

### SUMMARY

The present invention relates to an inductive position sensing system including an inductive position sensor and an electromagnetic barrier which shields the sensor from induced electromagnetic field interference. The electromagnetic barrier is formed of a soft magnetic composite material comprising a soft magnetic filler material dispersed within a non-magnetic matrix material. In one embodiment, the non-magnetic matrix material comprises a non-metallic material, and more specifically comprises a polymeric material. In another embodiment, the soft magnetic filler material comprises an iron-based material, and more specifically comprises iron powder particles, iron alloy powder particles, and/or other soft magnetic compound particles.

It is one object of the present invention to provide an improved inductive position sensing system that is shielded from the negative effects of electromagnetic field interference, and more specifically the eddy current induced effects resulting from metallic objects formed from iron, steel, copper, or aluminum positioned in close proximity to the inductive position sensor. Further objects, features, advantages, benefits, and aspects of the present invention will become apparent from the drawings and descriptions contained herein.

### BRIEF DESCRIPTION OF THE DRAWINGS

FIG. 1 is a perspective view of one embodiment of an induction-type position sensor for use in association with the present invention.

FIG. 2 is an elevational view of the inductive position sensor of FIG. 1.

FIG. 3 is a schematic representation of the inductive position sensor shown in FIG. 1.

FIG. 4 is a perspective view of another embodiment of an induction-type position sensor for use in association with the present invention.

FIG. 5 is an elevational view of the inductive position sensor of FIG. 4.

FIG. 6 is a schematic representation of the inductive position sensor shown in FIG. 4.

FIG. 7 is a perspective view of a cylindrical-shaped electromagnetic barrier according to one embodiment of the present invention.

FIG. 8 is an elevational view of the electromagnetic barrier shown in FIG. 7.

FIG. 9 is an end view of the electromagnetic barrier shown in FIG. 7.

FIG. 10 is a perspective view of a rectangular-shaped electromagnetic barrier according to another embodiment of the present invention.

FIG. 11 is a perspective view of a plate-shaped electromagnetic barrier according to a further embodiment of the present invention.

### DESCRIPTION OF EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is hereby intended, and that alterations and further modifications to the illustrated devices and/or further applications of the principles of the invention as illustrated herein are contemplated as would normally occur to one skilled in the art to which the invention relates.

Inductive position sensors and similar types of position sensors that utilize electromagnetic fields to sense the position of a movable device or structure are susceptible to electromagnetic interference, including electromagnetic field interference caused by eddy currents. As should be appreciated, electromagnetic interference could potentially lead to faulty operation of the sensor and/or erroneous sensor output. The present invention eliminates, or at least substantially reduces or minimizes, the negative effects on inductive position sensors caused by electromagnetic interference and eddy currents, while at the same avoiding or significantly limiting any degrading effects on sensor functionality and accuracy. In one aspect of the present invention, various types and configurations of electromagnetic barriers or housings are provided to shield inductive position sensors from electromagnetic field interference and/or resonant circuit detuning. Such barriers or housings will shield the inductive position sensors from signal losses caused by eddy currents generated in metallic objects formed of materials such as iron, steel, copper, or aluminum positioned in close proximity to the sensor. In one embodiment, the electromagnetic barrier is formed of a soft magnetic material, the details of which will be set forth below. The soft magnetic material significantly reduces inductive signal degradation caused by electro-mechanical devices or metal objects positioned in close proximity to inductive-type position sensors, while at the same time exhibiting a sufficient permeability with low magnetic reluctance and close to zero hysteresis to eliminate or at least limit degrading effects on sensor functionality and accuracy.

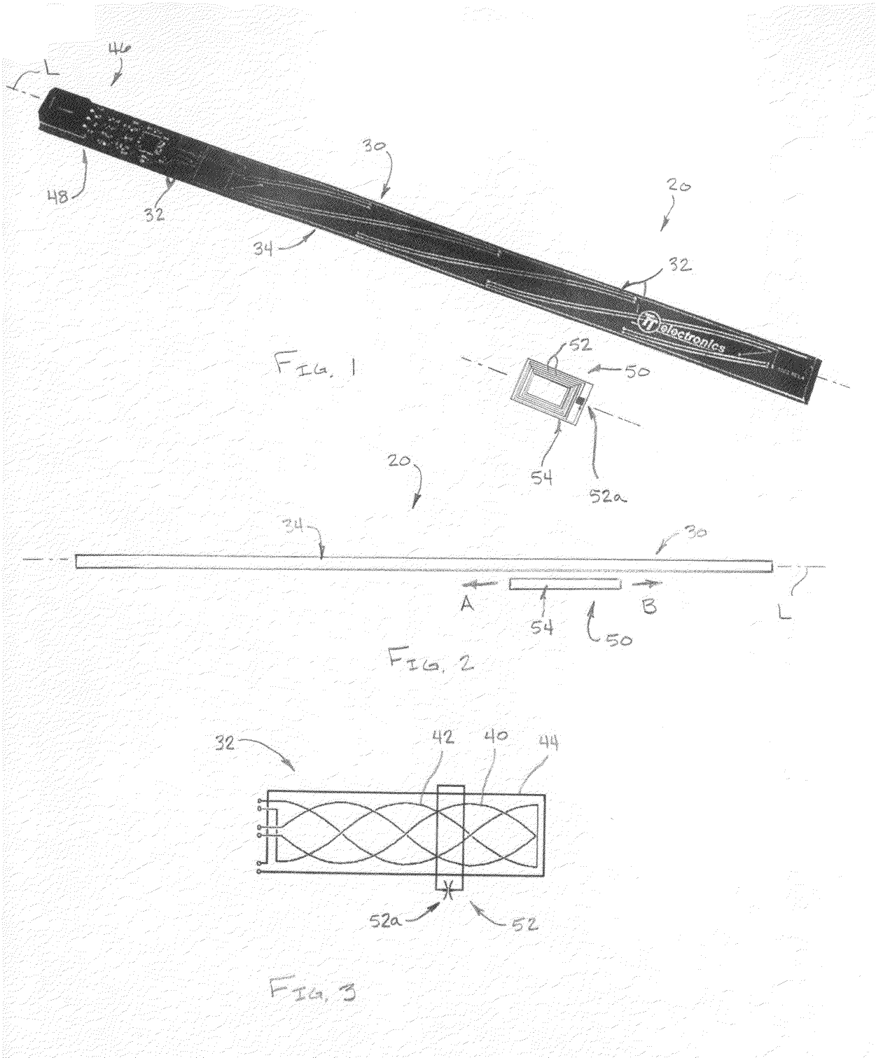

FIGS. 1-6 illustrate two embodiments of inductive-type position sensors that may be used in association with the present invention for sensing the position of a movable device or structure. However, it should be understood that other types and configurations of position sensors are also contemplated for use in association with the present invention.

Referring specifically to FIGS. 1-3, shown therein is one embodiment of an inductive position sensor 20 for use in association with the present invention. The inductive position sensor 20 is generally comprised of a stationary sensor element or pad 30 extending along a longitudinal axis L and including position sensor circuitry 32, and a movable sensor element or puck element 50 including radio frequency (RF) resonant position sensor circuitry 52. In one embodiment, the pad element 30 and the puck element 50 each have a substantially planar, plate-like configuration. In a specific embodiment, the pad element 30 and the puck element 50 each comprise a printed circuit board (PCB). However, other shapes and configurations of the pad element 30 and the puck element 50 are also contemplated. In a preferred embodiment, the pad element 30 is mounted in a stationary position, with the puck element 50 being movable relative to the stationary pad element 30, and with the puck element 50 mechanically coupled to a movable device (not shown) such that displacement of the movable device axially displaces the puck element 50 back and forth along the stationary pad element 30 in the directions of arrows A and B. However, it should be understood that in other embodiments, the puck element 50 may be mounted in a stationary position, with the pad element 30 being movable relative to the stationary puck element 50, and with the pad element 30 mechanically coupled to the movable device such that displacement of the movable device axially displaces the pad element 30 back and forth along the puck element 50.

In the illustrated embodiment, the pad element 30 and the puck element 50 are each arranged in a horizontal orientation. However, other embodiments are also contemplated wherein the pad element 30 and the puck element 50 may be arranged in a vertical orientation or other orientations. Additionally, in the illustrated embodiment, the puck element 50 is positioned below and displaced along a downwardly facing surface of the pad element 30. However, in another embodiment, the puck element 50 may be positioned above and displaced along an upwardly facing surface of the pad element 30. In the illustrated embodiment of the invention, the position sensor 20 is configured as a linear position sensor wherein movement of the puck element 50 relative to the pad element 30 comprises linear movement. However, other embodiments are also contemplated wherein the position sensor 20 may be configured as a rotary position sensor such that movement of puck element 50 relative to the pad element 30 comprises rotational movement. Additionally, although the travel path of the puck element 50 has been illustrated and described as being substantially linear, other travel paths are also contemplated, including arced or curved travel paths, curvilinear travel paths, or any other non-linear travel path that would occur to one of skill in the art.

In one embodiment, the pad element 30 including the position sensor circuitry 32 comprises a circuit board 34 onto which is printed conductive tracks or traces that are laid out to define coils or windings having particular shapes and configurations. Additionally, the puck element 50 including the resonant position sensor circuitry 52 comprises a circuit board 54 onto which is printed conductive tracks or traces that are laid out to define a rectangular-shaped resonant coil or winding, and further including a resonant capacitor 52a. As shown schematically in FIG. 3, the tracks or traces associated with the circuit board 34 are laid out to define a sine or transmit coil 40 and a cosine or transmit coil 42 which together comprise excitation windings, and a sense or receive coil 44 which comprises a sensor winding extending about the excitation windings.

In the illustrated embodiment, the sense coil 44 is configured as a loop having a rectangular shape. The sine coil 40 is located within the inner region of the sense coil 44 and is configured as a sine wave wherein a first half of the sine coil 40 is one-hundred and eighty electrical degrees out of phase relative to a second half. The sine coil 40 is positioned relative to the sense coil 44 at a “null point location”, wherein electromagnetic signals transmitted from each half the sine coil 40 and received by the sense coil 44 are one-hundred and eighty degrees out of phase so as to cancel each other. Similarly, the cosine coil 42 is located within the inner region of the sense coil 44 and is configured as a cosine wave positioned relative to the sense coil 44 at a “null point location”, wherein the electromagnetic signals transmitted from the cosine coil 42 and received by the sense coil 44 cancel one another out. Under normal operating conditions, the electromagnetic signals generated by the sine and cosine coils 40, 42 and received by the sense coil 44 are nulled or balanced out within the sense coil 44. As should be appreciated, if the electromagnetic signals within the sense coil 44 are not cancelled out and become unbalanced as a result of some physical phenomenon, such as the effects of electromagnetic interference, proper functioning of the inductive position sensor 20 may be negatively affected.

In the illustrated embodiment, the circuit board 34 associated with the pad element 30 is elongated along the longitudinal axis L and has a planar, rectangular-shaped configuration. However, other shapes and configurations are also contemplated. Furthermore, in addition to the traces forming the coils 40, 42 and 44, the circuit board 34 may also be provided with position sensor control circuitry 46 including, for example, a position sensor control unit 48 integrated onto an end portion of the circuit board 34. In one embodiment, the position sensor control unit 48 may be provided as an application specific integrated circuit (ASIC) integrated onto the circuit board 34. However, other types and configurations of position sensor control circuitry are also contemplated as would be apparent to one of ordinary skill in the art. Additionally, in the illustrated embodiment, the circuit board 54 associated with the puck element 50 also has a planar, rectangular-shaped configuration. However, once again, other shapes and configurations are also contemplated.

The resonant coil 52 including the resonant capacitor 52a form a radio frequency (RF) resonant circuit that is positioned in close proximity to the sine, cosine and sensor coils 40, 42 and 44 so as to electromagnetically couple the resonant coil 52 to the sine and cosine coils 40 and 42. Electromagnetic energy generated by the sine and cosine coils 40 and 42 is transmitted to and received by the resonant coil 52. The resonant coil 52 receives electromagnetic energy from both the sine and cosine coils 40 and 42, which in turn generates a circulating resonant current within the resonant coil 52. The resonant coil 52 is also electromagnetically coupled to the sense coil 44, and electromagnetic energy generated by the circulating current within the resonant coil 52 is transmitted to and received by the sense coil 44. An electronic signal is generated within the sense coil 44 which corresponds to the physical position of the resonant coil 52 relative to the sine, cosine and sense coils 40, 42 and 44, which in turn corresponds to the physical position of the puck element 50 relative to the pad element 30. As indicated above, since the puck element 50 is fixedly coupled to a movable device (not shown), the electrical signal generated within the sense coil 44 corresponds to a particular position of the movable device. The electronic signal generated within the sense coil 44 (which corresponds to the position of the puck element 50 relative to the pad element 30) is transmitted to the position sensor control circuitry 46. The position sensor control circuitry 46 in turn generates an output signal corresponding to the particular position of the movable device (not shown), with the output signal being transmitted to other electronic systems or control units via wires or leads. In one embodiment, the sensor output signal comprises a voltage signal falling with a range of 0.2V DC to 4.8V DC. However, other types of output signals and output signal ranges are also contemplated as would occur to one of skill in the art.

From the discussion set forth above, one skilled in the art would understand that the electronic position sensor circuitry 32 is adjusted to function at the resonant frequency of the RF resonant circuit elements 52 and 52a. Once the electronic position sensor circuitry 32 is adjusted to function at a particular resonant frequency, such adjustment is permanent and does not change. Additionally, it should be understood that when the resonant coil 52 is positioned in close proximity to metallic objects formed of, for example, iron, steel, copper, or aluminum, the induced eddy current generated effects will lower the inductance of the resonant coil 52, which will in turn increase the resonant frequency of the resonant circuit formed by the circuit elements 52 and 52a. Also, the close proximity of iron, steel, copper, or aluminum materials will cause the null point set up between the sine and cosine coils 40, 42 with respect to the sense coil 44 to become unbalanced. As should be appreciated, the increased resonant frequency in the resonant circuitry 52, 52a and/or the unbalanced condition in the sensor circuitry 32 will adversely affect operation of the inductive position sensor 20 and the accuracy of the position sensor output signal.

Further details regarding an inductive position sensor configured similar to the position sensor 20 are illustrated and described in U.S. Pat. No. 7,208,945 to Jones et al., the contents of which are incorporated herein by reference in their entirety. Although a particular configuration of the inductive position sensor 20 is illustrated and described herein, it should be understood that other types and configurations of inductive position sensors are also contemplated for use in association with the present invention.

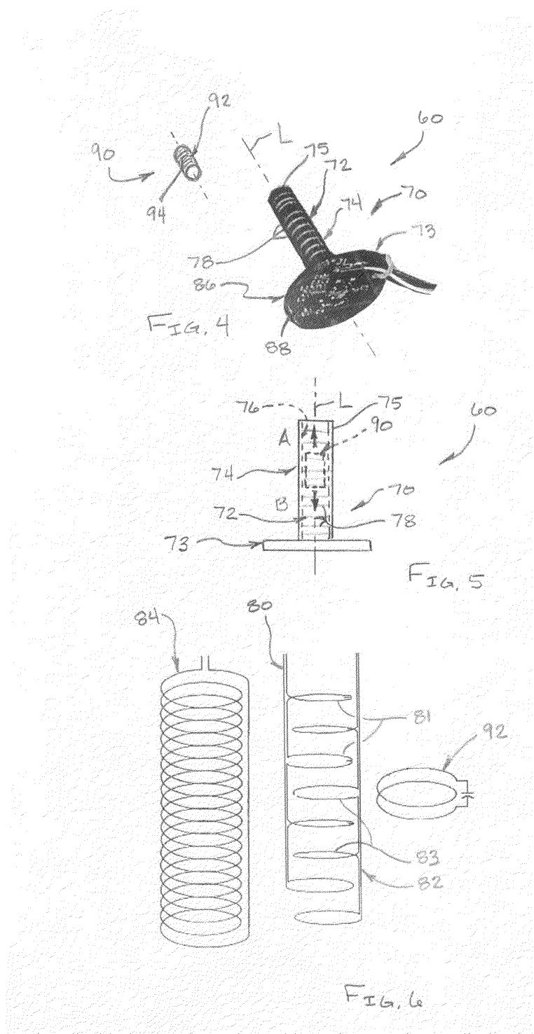

Referring to FIGS. 4-6, shown therein is another embodiment of an inductive position sensor 60 for use in association with the present invention. The inductive position sensor 60 is generally comprised of a stationary sensor element or bobbin 70 extending along a longitudinal axis L and including position sensor circuitry 72, and a movable sensor element or core 90 including radio frequency (RF) resonant position sensor circuitry 92. In the illustrated embodiment, the bobbin element 70 and the core element 90 each have a circular configuration. More specifically, the bobbin element 70 includes a disc-shaped base portion 73 and a cylindrical-shaped body portion 74 extending from the base portion 73 and including a side wall 75 defining an interior passage 76 extending along the longitudinal axis L and having a substantially circular inner cross section. Additionally, the core element 90 has a substantially circular outer cross section and is positioned within and axially displaceable along the interior passage 76. However, other shapes and configurations of the bobbin element 70 and the core element 90 are also contemplated.

In a specific embodiment, the bobbin element 70 and the core element 90 are formed of a plastic or polymeric material. In a preferred embodiment, the bobbin element 70 is mounted in a stationary position, with the core element 90 being axially displaceable within the interior passage 76 of the bobbin element 70, and with the core element 90 mechanically coupled to a movable device (not shown) such that displacement of the movable device axially displaces the core element 90 back and forth within the interior passage 76 in the directions of arrows A and B. However, it should be understood that in other embodiments, the core element 90 may be mounted in a stationary position, with the bobbin element 70 being movable relative to the stationary core element 90, and with the bobbin element 70 mechanically coupled to the movable device such that displacement of the movable device axially displaces the bobbin element 70 back and forth along the stationary core element 90.

In the illustrated embodiment of the invention, the bobbin element 70 and the core element 90 are each arranged in a vertical orientation. However, other embodiments are also contemplated wherein the bobbin element 70 and the core element 90 may be arranged in a horizontal orientation or other orientations. Additionally, in the illustrated embodiment, the core element 90 is positioned within and displaced axially along the interior passage 76 of the bobbin element 70. However, in an alternative embodiment, the core element 90 may be provided with a ring-shaped configuration having a central opening, with the cylindrical portion 74 of the bobbin element 70 positioned within the central opening, and with the ring-shaped element axially displaceable along the exterior of the cylindrical portion.

In one embodiment, the bobbin element 70 including the position sensor circuitry 72 includes wires or leads 78 at least partially embedded within the sidewall 75 of the cylindrical body portion 74, and which are wound about the cylindrical body portion 74 and laid out to define coil windings having particular shapes and configurations. Additionally, the core element 90 including the RF resonant position sensor circuitry 92 includes wires or leads 94 at least partially embedded within and wound about the core element 90 to define a resonant coil winding. In one embodiment of the invention, the wires or leads 78 and 94 are formed of copper. However, other suitable materials are also contemplated as would occur to one of skill in the art.

As shown schematically in FIG. 6, the wires 78 wound about the cylindrical body portion 74 of the bobbin element 70 are laid out to define a sine coil 80 and a cosine coil 82 which together comprise excitation windings, and a receive coil 84 having a helical configuration which comprises a sensor winding. However, in an alternative embodiment, the helical coil 84 may comprise an excitation winding, and the sine coil 80 and the cosine coil 82 may together comprise sensor windings. The sine coil 80 is located within the inner region of the sense coil 84 at a “null point location”, and includes a series of circular windings 81 extending about the sidewall 75 of the cylindrical body portion 74 of the bobbin element 70. Similarly, the cosine coil 82 is located within the inner region of the sense coil 84 at a “null point location”, and includes a series of circular windings 83 extending about the sidewall 75 of the cylindrical body portion 74 of the bobbin element 70 and positioned intermediate adjacent pairs of the circular windings 81 of the sine coil 80. Under normal operating conditions, the electromagnetic signals generated by the sine and cosine coils 80, 82 and received by the sense coil 84 are nulled or balanced out within the sense coil 84. As should be appreciated, if the electromagnetic signals within the sense coil 84 are not cancelled out and become unbalanced as a result of some physical phenomenon, such as the effects of electromagnetic interference or induced eddy currents, proper functioning of the inductive position sensor 60 and sensor output may be negatively affected.

In the illustrated embodiment of the invention, the disc-shaped base portion 73 of the bobbin element 70 includes position sensor control circuitry 86 including, for example, a position sensor control unit 88. In one embodiment, the position sensor control unit 88 is provided as an application specific integrated circuit (ASIC) integrated onto the disc-shaped base portion 73. However, other types and configurations of position sensor control circuitry are also contemplated as would be apparent to one of skill in the art. The resonant coil 92 is positioned in close proximity to the sine, cosine and sensor coils 80, 82 and 84 so as to electromagnetically couple the resonant coil 92 to the sine and cosine coils 80 and 82. Electromagnetic energy generated by the sine and cosine coils 80 and 82 is transmitted to and received by the resonant coil 92. The resonant coil 92 receives electromagnetic energy from both the sine and cosine coils 80 and 82, which in turn generates a circulating resonant current within the resonant coil 92. The resonant coil 92 is electromagnetically coupled to the sense coil 84, and electromagnetic energy generated by the circulating current within the resonant coil 92 is transmitted to and received by the sense coil 84.

An electronic signal is generated within the sense coil 84 which corresponds to the physical position of the resonant coil 92 relative to the sine, cosine and sense coils 80, 82 and 84, which in turn corresponds to the relative physical position of the core element 90 within the interior passage 76 of the bobbin element 70. As indicated above, since the core element 90 is fixedly coupled to a movable device (not shown), the electrical signal generated within the sense coil 84 corresponds to a particular position of the movable device. The electronic signal generated within the sense coil 84 (which corresponds to the relative position of the core element 90 within the interior passage 76 of the bobbin element 70) is transmitted to the position sensor control circuitry 86. The position sensor control circuitry 86 in turn generates an output signal corresponding to the position of the movable device (not shown), with the output signal being transmitted to other electronic systems or control units via wires or leads. In one embodiment, the output signal comprises a voltage signal falling with a range of 0.2V DC to 4.8V DC. However, other types of output signals and output signal ranges are also contemplated as would occur to one of skill in the art.

From the discussion set forth above, one skilled in the art would understand that the electronic position sensor circuitry 72 is adjusted to function at the resonant frequency of the RF resonant circuitry 92. Once the electronic position sensor circuitry 72 is adjusted to function at a particular resonant frequency, such adjustment is permanent and does not change. Additionally, it should be understood that when the resonant circuitry 92 is positioned in close proximity to metallic objects formed of, for example, iron, steel, copper, or aluminum, the induced eddy current generated effects will lower the inductance of the resonant coil 92, which will in turn increase the resonant frequency of the resonant circuit formed by the resonant circuitry 92. Also, the close proximity of iron, steel, copper, or aluminum materials will cause the null point set up between the sine and cosine coils 80, 82 with respect to the sense coil 84 to become unbalanced. As should be appreciated, the increased resonant frequency in the resonant circuitry 92 and/or the unbalanced condition in the sensor circuitry 72 will adversely affect operation of the inductive position sensor 60 and the accuracy of the position sensor output signal.

Further details regarding an inductive position sensor similar to the position sensor 60 are illustrated and described in U.S. Pat. No. 6,561,022 to Doyle et al., the contents of which are incorporated herein by reference in their entirety. Although a particular configuration of the inductive position sensor 60 is illustrated and described herein, it should be understood that other types and configurations of inductive position sensors are also contemplated for use in association with the present invention.

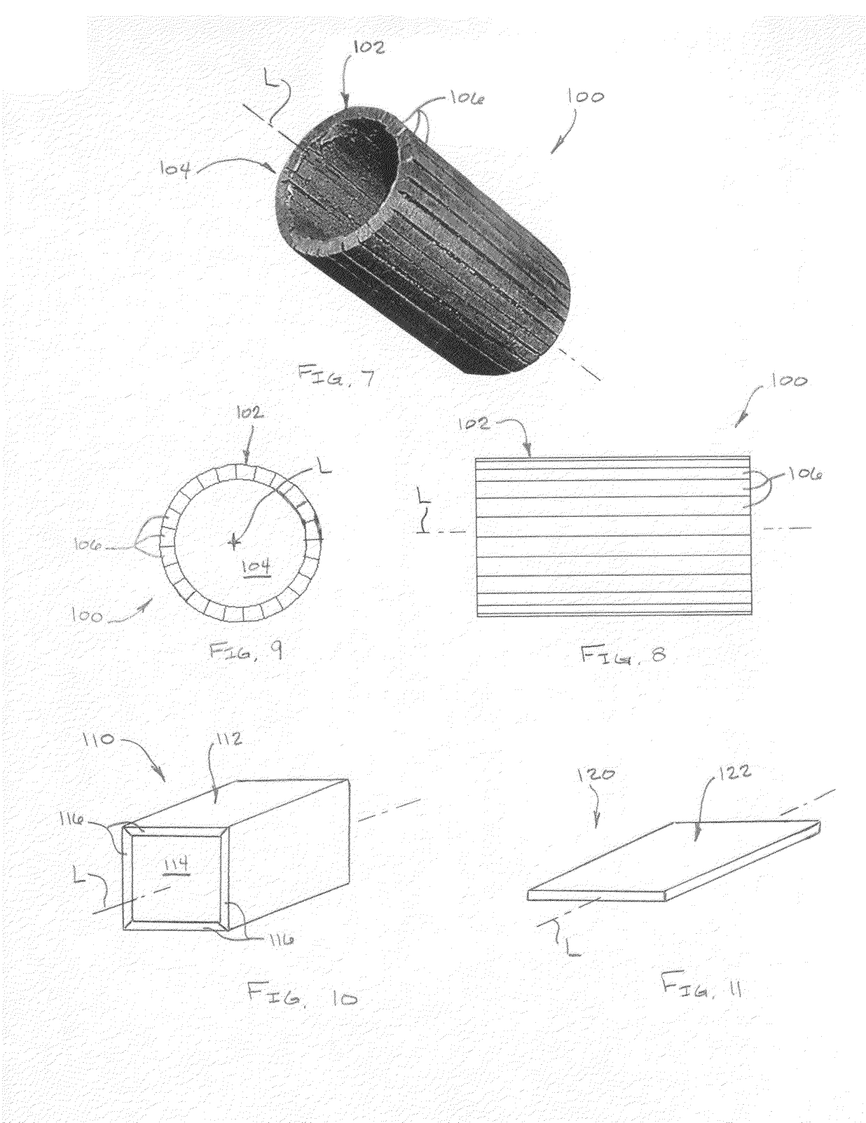

Referring to FIGS. 7-11, shown therein are electromagnetic barriers or shields 100, 110 and 120 according to various embodiments of the present invention. As indicated above, the electromagnetic barriers are used in association with inductive position sensors to shield the sensors from induced electromagnetic field interference. Each of the electromagnetic barriers 100, 110 and 120 is formed of a soft magnetic composite material comprising a soft magnetic filler material dispersed within a non-magnetic matrix material or binder material. In one embodiment, the soft magnetic composite material has a magnetic reluctance that is less than the magnetic reluctance of cold rolled steel (CRS). In another embodiment, the non-magnetic matrix material comprises a non-metallic material. In specific embodiments, the non-metallic matrix material comprises a polymeric material, such as, for example, a nylon material. However, other non-metallic matrix materials or binder materials are also contemplated, including, for example, plastic materials, fiberglass materials, resins, or any other suitable non-metallic materials. In a further embodiment, the soft magnetic filler material comprises an iron-based material. In a specific embodiment, the iron-based material comprises iron particles, such as, for example, iron powder particles, iron alloy powder particles, and/or other soft magnetic compound particles. It should be understood that the particular composition of the soft magnetic material may be adjusted or varied depending on the requirements or environmental conditions associated with the particular application of the electromagnetic barrier. For example, some applications may require a higher percentage of the soft magnetic filler material relative to the non-magnetic matrix material, while other applications may require a lower percentage of the soft magnetic filler material relative to the non-magnetic matrix material.

As should be appreciated, forming the electromagnetic barriers or shields 100, 110 and 120 from a soft magnetic composite material including a polymeric/plastic/resin matrix or binding material allows the electromagnetic barriers to be created via extrusion or molding techniques. Such techniques include, for example, extrusion of single-piece electromagnetic barriers, extrusion of individual barrier components or pieces that are subsequently assembled to form an integral electromagnetic barrier, and/or molding of a single-piece barrier or individual barrier components via injection molding, compression molding, transfer molding, or any other suitable molding technique. As a result, the electromagnetic barriers can be easily and inexpensively designed and produced in a wide variety of shapes, sizes and configurations. Notably, extrusion or molding techniques may be more economical than machining or stamping techniques. However, it should be understood that formation of the electromagnetic barriers or barrier components can also be provided via machining or stamping techniques, or other fabrication techniques or processes.

Referring collectively to FIGS. 7-9, shown therein is an electromagnetic barrier or shield 100 having a cylindrical-shaped configuration. The cylindrical barrier 100 includes a peripheral sidewall 102 extending about an interior region 104 defined along a longitudinal axis L. In the illustrated embodiment, the sidewall 102 is formed by a number of individual axial segments or strips of material 106 that are assembled and joined together to form the cylindrical barrier 100. Forming the sidewall 102 from a number of the individual axial strips of material 106 is advantageous in that elements having a solid configuration and a basic geometric profile are particularly well suited for formation via an extrusion process. However, it should be understood that the sidewall 102 may alternatively be formed as an integral, single-piece structure. In the illustrated embodiment, the sidewall 102 is formed from twenty-four (24) axial strips of material 106, with each strip of material 106 extending about 15 degrees of the overall circumference of the sidewall 102. However, other embodiments are also contemplated where the cylindrical barrier 100 is formed from any number of the axial strips of material 106.

Although the barrier 100 is illustrated as having a cylindrical shape, it should be understood that barriers having other shapes and configurations are also contemplated, including elliptical or oval configurations, curvilinear configurations, square or rectangular configurations (FIG. 10), triangular configurations, polygonal configurations, or any other suitable configuration that would occur to one of skill in the art. In the illustrated embodiment, the sidewall 102 of the cylindrical barrier 100 extends entirely about the interior region 104 to form a peripherally-enclosed barrier housing. However, it should be understood that in other embodiments, the sidewall 102 may extend partly about the interior region 104 to form a partially-enclosed barrier housing. It should also be understood that one or both ends of the sidewall 102 may be closed off by end wall to further enclose the interior region 104 of the cylindrical barrier 100.

As should be appreciated, the size of the cylindrical barrier 100 may be varied to accommodate different types, sizes and shapes of inductive position sensors. In one embodiment, the cylindrical barrier 100 has a length extending along the entire length of the inductive position sensor. However, in other embodiments, the cylindrical barrier 100 may be provided with a length extending along a select portion of the inductive position sensor, such as, for example, along the length of the RF resonant circuit element. With regard to the inductive position sensor 60 illustrated and described above, the cylindrical barrier 100 may be sized to receive and enclose the cylindrical body portion 74 of the bobbin element 70, with the disc-shaped end portion 73 remaining outside of the interior region 104. However, in other embodiments, the cylindrical barrier 100 may be sized to peripherally enclose the bobbin element 70. Similarly, with regard to the inductive position sensor 20, the cylindrical barrier 100 may be provided with a length extending entirely along or partially along the length of the sensor pad element 30. It should also be appreciated that the thickness of the barrier sidewall 102 has an effect on the shielding characteristics of the barrier, and that the thickness of the sidewall 102 may be selected depending on the requirements and environmental conditions associated with the particular application of the inductive position sensor.

Referring to FIG. 10, shown therein is an electromagnetic barrier or shield 110 having a rectangular-shaped configuration. The rectangular barrier 110 includes a peripheral sidewall 112 extending about an interior region 114 defined along a longitudinal axis L. In the illustrated embodiment, the sidewall 112 is formed by a four axial segments or plates of material 116 that are assembled and joined together to form the rectangular barrier 110. However, in another embodiment, the sidewall 112 may be formed as an integral, single-piece structure. Additionally, although the sidewall 112 is illustrated as extending entirely about the interior region 114 to form a peripherally-enclosed barrier housing, in other embodiments, the sidewall 112 may be designed to extend partly about the interior region 114 to form a partially-enclosed barrier housing. It should also be understood that one or both ends of the sidewall 112 may be closed off by an end wall to further enclose the interior region 114 of the rectangular barrier 110. It should further be understood that the size of the barrier 110 may be varied to accommodate different types, sizes and shapes of inductive position sensors, and the thickness of the barrier sidewall 112 may be selected depending on the requirements and environmental conditions associated with the particular application of the inductive position sensor.

Referring to FIG. 11, shown therein is an electromagnetic barrier or shield 120 that has a flat/planar configuration. The barrier 120 is formed as a substantially flat/planar plate or sheet of material 122 extending along a longitudinal axis L. In the illustrated embodiment, the barrier plate 122 has a rectangular shape. However, other shapes of the barrier plate 122 are also contemplated. The barrier 120 is particularly suitable for use in association with inductive position sensors having a flat/planar configuration, such as, for example, the inductive position sensor 20 illustrated and described above. As should be appreciated, one of the barrier plates 122 may be positioned adjacent either side of the sensor pad 30 and extending partially or entirely along the length of the sensor pad 30. Additionally, as discussed above, the thickness of the barrier plate 122 may be selected depending on the requirements and environmental conditions associated with the particular application of the inductive position sensor.

As indicated above, inductive position sensors, such as, for example, the inductive position sensors 20 and 60, utilize electromagnetic fields to sense the position of a movable device. However, as also indicated above, the electromagnetic fields utilized by inductive position sensors may be susceptible to electromagnetic field interference, including induced electromagnetic interference resulting from eddy currents generated by metallic objects formed of material such as iron, steel, copper, and aluminum positioned in close proximity to the inductive position sensor. As should be appreciated, such interference could potentially lead to faulty operation of the inductive position sensor and/or erroneous sensor output.

The soft magnetic material from which the electromagnetic barriers 100, 110 and 120 are formed eliminates or substantially reduces/minimizes the negative effects on inductive position sensors caused by induced electromagnetic field interference, and also eliminates or substantially reduces/minimizes any unbalancing effects on the electromagnetic sensor fields caused by positioning of objects formed of iron, steel, copper, or aluminum in close proximity to the sensors. Additionally, the soft magnetic material eliminates or significantly limits any degrading effects on sensor functionality and accuracy, and exhibits a permeability having low magnetic reluctance and close to zero hysteresis with minimal degrading or RF resonant detuning effects on sensor performance. The soft magnetic material also permits the electromagnetic flux density generated by the inductive position sensor to flow through the barrier instead of adjacent metallic objects formed of iron, steel, copper, or aluminum, thereby preventing or minimizing generation of eddy currents and inductance-reducing counter electromagnetic flux density. The electromagnetic flux density that would, under normal circumstances, generate an eddy current induced counter electromagnetic flux density is reduced or eliminated by positioning the electromagnetic barrier 100, 110 and 120 between the inductive position sensor and the object or device that might otherwise electromagnetically interfere with proper operation and functioning of the inductive position sensor.

As should be appreciated, in view of the shielding characteristics provided by the electromagnetic barriers of the present invention, inductive position sensors may be located within or adjacent objects or devices that might otherwise electromagnetically interfere with sensor operation and accuracy. For example, inductive position sensors may be located within support structures or housings formed of iron, steel, copper, or aluminum if used in association with an electromagnetic barrier to shield the inductive position sensor from electromagnetic interference.

While the invention has been illustrated and described in detail in the drawings and foregoing description, the same is to be considered as illustrative and not restrictive in character, it being understood that all changes and modifications that come within the spirit of the invention are desired to be protected.

What is claimed is:

1. An inductive position sensing system, comprising:
an inductive position sensor configured to sense the relative position of a movable device and including first and second sensor elements, said first sensor element mechanically coupled to the movable device such that displacement of the movable device correspondingly displaces said first sensor element relative to said second sensor element, and wherein one of said first and second sensor elements includes excitation and sensor circuitry, and the other of said first and second sensor elements includes radio frequency resonator circuitry, said first and second sensor elements positioned in close proximity such that said radio frequency resonator circuitry is electromagnetically coupled to said excitation and sensor circuitry, and wherein displacement of said first sensor element relative to said second sensor element results in displacement of said radio frequency resonator circuitry relative to said excitation and sensor circuitry which generates an electrical signal within said sensor circuitry corresponding to a position of the movable device; and
an electromagnetic barrier positioned adjacent said inductive position sensor to shield said inductive position sensor from electromagnetic field interference including destructive eddy current induced effects, said electromagnetic barrier formed of a soft magnetic composite material comprising a soft magnetic filler material dispersed within a non-magnetic matrix material.

2. The inductive position sensing system of claim 1, wherein said non-magnetic matrix material comprises a non-metallic material.

3. The inductive position sensing system of claim 2, wherein said non-metallic material comprises a polymeric material.

4. The inductive position sensing system of claim 3, wherein said polymeric material comprises a nylon material.

5. The inductive position sensing system of claim 2, wherein said non-metallic material comprises a plastic material.

6. The inductive position sensing system of claim 1, wherein said soft magnetic filler material comprises an iron-based material.

7. The inductive position sensing system of claim 6, wherein said iron-based material comprises powder particles comprising iron or an iron alloy.

8. The inductive position sensing system of claim 7, wherein said powder particles are dispersed within a polymeric matrix material.

9. The inductive position sensing system of claim 1, wherein said soft magnetic composite material has a magnetic reluctance less than a magnetic reluctance of steel.

10. The inductive position sensing system of claim 1, wherein said electromagnetic barrier comprises a housing having a cylindrical-shaped outer cross section defining an interior region, said inductive position sensor at least partially positioned within said interior region.

11. The inductive position sensing system of claim 10, wherein said electromagnetic barrier is formed of a plurality of extruded strips, said extruded strips interconnected to form said housing.

12. The inductive position sensing system of claim 1, wherein said electromagnetic barrier comprises a housing having a rectangular-shaped outer cross section defining an interior region, said inductive position sensor at least partially positioned within said interior region.

13. The inductive position sensing system of claim 12, wherein said electromagnetic barrier is formed of a plurality of extruded plates, said extruded plates interconnected to form said housing.

14. The inductive position sensing system of claim 1, wherein said electromagnetic barrier comprises a substantially planar plate.

15. The inductive position sensing system of claim 1, wherein said electromagnetic barrier comprises an extrusion.

16. The inductive position sensing system of claim 1, wherein said electromagnetic barrier comprises a molded structure.

17. The inductive position sensing system of claim 1, wherein said first and second sensor elements including said circuitry each have a substantially planar plate-like configuration.

18. The inductive position sensing system of claim 17, wherein said first and second sensor elements including said circuitry each comprise a printed circuit board.

19. The inductive position sensing system of claim 1, wherein said first and second sensor elements including said circuitry each have circular configuration.

20. The inductive position sensing system of claim 19, wherein one of said first and second sensor elements defines an interior passage having a substantially circular inner cross section, the other of said first and second sensor elements having a substantially circular outer cross section and positioned within and displaceable along said interior passage.
